(19) United States
(12) Patent Application Publication
(10) Pub. No.: US 2023/0091050 A1
(43) Pub. Date: Mar. 23, 2023

(54) OPTICAL WAVEGUIDES WITHIN A GLASS SUBSTRATE TO OPTICALLY COUPLE DIES ATTACHED TO THE GLASS SUBSTRATE

(71) Applicant: Intel Corporation, Santa Clara, CA (US)

(72) Inventors: Zhichao ZHANG, Chandler, AZ (US); Pooya TADAYON, Portland, OR (US); Tarek A. IBRAHIM, Tempe, AZ (US); Srinivas V. PIETAMBARAM, Chandler, AZ (US); Changhua LIU, Chandler, AZ (US); Kemal AYGÜN, Tempe, AZ (US)

(21) Appl. No.: 17/479,031

(22) Filed: Sep. 20, 2021

(51) Int. Cl. G02B 6/42

(52) U.S. Cl. CPC G02B 6/4214

(57) ABSTRACT

Embodiments described herein may be related to apparatuses, processes, and techniques directed to optical interconnects and optical waveguides within a glass layer of a semiconductor package, where dies that are physically and optically coupled with the glass layer are optically coupled with each other via the optical waveguides. One or more reflectors may be used to direct the optical pathway through the glass layer. Other embodiments may be described and/or claimed.

### FIELD

Embodiments of the present disclosure generally relate to the field of semiconductor packaging, and in particular to optical coupling of dies using a glass substrate.

### BACKGROUND

Continued growth in computing and mobile devices will continue to increase the demand for the number of dies within semiconductor packages.

### BRIEF DESCRIPTION OF THE DRAWINGS

FIG. 1 illustrates a cross-section side view and a top-down view of a package that includes a computing die optically coupled with other dies using a waveguide within a glass layer, in accordance with various embodiments.

FIG. 2 illustrates a cross-section side view of a package that includes a computing die optically coupled with other dies using multiple waveguides within multiple glass layers, in accordance with various embodiments.

FIG. 3 illustrates a cross-section side view of a package that includes a computing die that is optically coupled with a waveguide in a glass layer that is at multiple depths within the glass layer, in accordance with various embodiments.

FIG. 4 illustrates a cross-section side view of a package that includes a computing die that is optically coupled in serial with multiple optical waveguides, in accordance with various embodiments.

FIG. 5 illustrates cross-section side views of a package that includes a computing die that is optically coupled with a multilayer waveguide with different types of optical reflectors, in accordance with various embodiments.

FIGS. 6A-6E illustrate stages in a manufacturing process for multiple waveguides in a glass layer, in accordance with various embodiments.

FIGS. 7A-7K illustrate stages in a manufacturing process for multiple waveguides using multiple glass layers, in accordance with various embodiments.

FIG. 8 illustrates multiple examples of laser-assisted etching of glass interconnects processes, in accordance with various embodiments.

FIG. 9 illustrates an example of a process for creating a waveguide in a glass layer, in accordance with various embodiments.

FIG. 10 schematically illustrates a computing device, in accordance with various embodiments.

### DETAILED DESCRIPTION

Embodiments described herein may be related to apparatuses, processes, and techniques related to creating optical interconnects and optical waveguides within glass layers, which also may be referred to as glass substrates. These optical interconnects and optical waveguides provide long, high-speed communication paths between dies, increasing die reach and higher die count integration on multichip packages (MCP) built on glass layers. In embodiments, these optical interconnects and optical waveguides, including multilayer optical waveguides, may be created using laser writing techniques at various depths of glass layers, or hermetic bonding or eutectic bonding of separate glass layers or glass interposers.

In embodiments, the number of dies, the die to die reach (distances), and total input/output (I/O) bandwidth on an MCP may be dramatically increased using optical connectivity that includes optical waveguides within glass layers. In addition, high-speed connections between dies, which may be previously accomplished only using high-speed electrical bridges between adjacent dies, now may be achieved between dies that are not adjacent, and may be several millimeters or more apart. This facilitates increased MCP scalability. In addition, embodiments reduce the number of links required between dies, and also supports non-straight interconnects for routing flexibility between photonic ICs (PICs) that may be included as a part of a die or a chiplet. This is due to reduction I/O density in optical interconnects by a factor of at least five compared to electrical interconnects.

In legacy implementations, MCPs based on electrical silicon bridges or silicon interposer connections use parallel I/O with high density. However, these implementations support a die to die reach of only a few millimeters. As a result, these legacy techniques are limited to latterly adjacent dies, which constrains the number of dies that may be integrated into a package. Legacy MCPs that are based on legacy organic packages may have a reach of tens of millimeters, but are subject to bandwidth density issues due to substrate design rules.

High performance and complexity processor products, which may be referred to as xPUs, are migrating to heterogeneously integrated architectures within a MCP configuration. This is due to the need to include a higher level of functionality integrated at the die level, to avoid large dies that result in lower yield and higher cost, and to gain the ability to integrate chiplets of various process nodes through advanced packaging processes.

Legacy implementations of MCP use electrical interconnects that are implemented using advanced organic packaging technologies with fine line width and spacing, implemented using silicon bridges or silicon interposers. A common characteristic of legacy MCP interconnects is to use high density I/O at relatively lower speed to achieve the total high bandwidth, hence the reach of the interconnects is very short and limited to a few millimeters. This means that the die to die interconnects are only done for adjacent dies that are a small distance apart, limiting the number of dies that can be interconnected and integrated.

Legacy optical signaling technologies are able to support long-haul distances, covering several feet, miles, or more, and have characteristics that include high bandwidth density. In embodiments described herein, optical signal technologies are implemented within MCP architectures, including such features as optical waveguides within glass layers, and reflectors within glass layers to form an optical path within the glass layer. In embodiments, multiple optical glass layers may be formed, and may be used to provide expanded bandwidth and capability to reach nonadjacent dies within the MCP. In embodiments, the ability to form waveguides at different levels within a glass layer or glass substrate also provides additional flexibility to extend high-bandwidth communications underneath dies.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

Various operations may be described as multiple discrete operations in turn, in a manner that is most helpful in understanding the claimed subject matter. However, the order of description should not be construed as to imply that these operations are necessarily order dependent.

As used herein, the term “module” may refer to, be part of, or include an ASIC, an electronic circuit, a processor (shared, dedicated, or group) and/or memory (shared, dedicated, or group) that execute one or more software or firmware programs, a combinational logic circuit, and/or other suitable components that provide the described functionality.

Various Figures herein may depict one or more layers of one or more package assemblies. The layers depicted herein are depicted as examples of relative positions of the layers of the different package assemblies. The layers are depicted for the purposes of explanation, and are not drawn to scale. Therefore, comparative sizes of layers should not be assumed from the Figures, and sizes, thicknesses, or dimensions may be assumed for some embodiments only where specifically indicated or discussed.

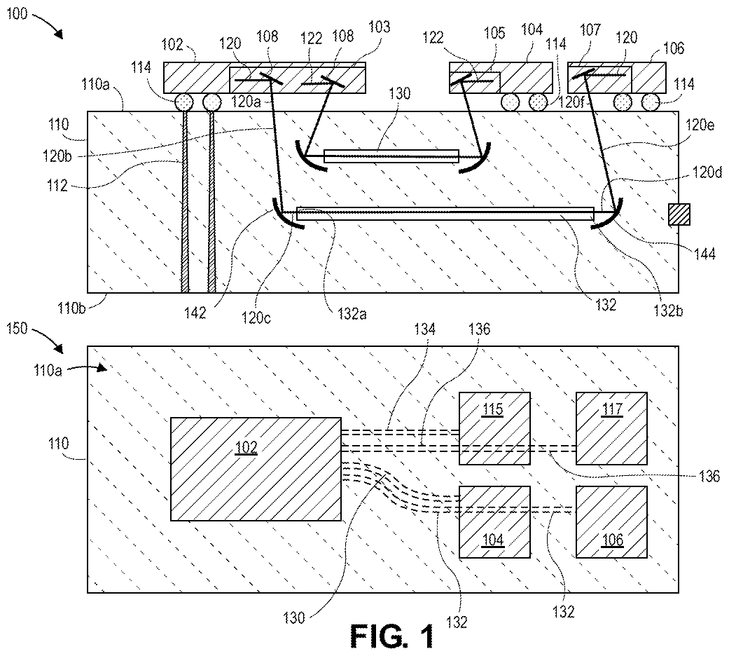

FIG. 1 illustrates a cross-section side view and a top-down view of a package that includes a computing die optically coupled with other dies using an optical waveguide within a glass layer, in accordance with various embodiments. Package 100 is a MCP that includes a computing die 102, and additional dies first die 104 and second die 106, which may be high-bandwidth memory (HBM) or other types of dies that may require high-speed communication with the computing die 102.

In embodiments the computing die 102 may include PIC circuitry 103, the first die 104 may include PIC circuitry 105, and the second die 106 may include PIC circuitry 107. In embodiments, the PIC circuitry 103, 105, 107 may include optical circuitry to generate and receive optical signals along one or more optical routes 120, 122. The PIC circuitry 103, 105, 107 may include optical components, such as reflectors 108 that may be used to change the direction of optical signals generated or received by the PIC circuitry.

In embodiments, the computing die 102, the first die 104, and the second die 106 may be physically and optically coupled with a glass layer 110. In embodiments, the glass layer 110 may also be referred to as a glass substrate. In embodiments, the glass layer 110 may include one or more through glass vias (TGV) 112 filled with conductive material, such as copper, that may be used to electrically couple the computing die 102 at the first side 110a of the glass layer 110 with a second side 110b of the glass layer 110 opposite the first side. As shown, the computing die 102 may be electrically coupled with the TGV 112 using solder connections 114.

In embodiments, a first optical waveguide 132 may be used to optically couple the computing die 102 with the second die 106 along a first optical route 120, and a second optical waveguide 130 may be used to optically couple the computing die 102 with the first die 104 along a second optical route 122. As shown, the first optical route 120 may be broken into a series of optical segments 120a, 120b, 120c, 120d, 120e, 120f.

Optical segment 120a is a portion of the optical path between the PIC 103 and the top 110a of the glass layer 110. Optical segment 120a may exist through the air between the computing die 102 and the glass layer 110. In embodiments, a transparent underfill (not shown) below computing die 102 may be used as an optical transmission medium.

Optical segment 120b is a portion of an optical path within the glass layer 110 to transmit light from the top 110a of the glass layer 110 to a first reflector 142 within the glass layer 110. In embodiments, the first reflector 142 may be a curved reflector, as shown, or may be a flat reflector, such as reflector 108 within computing die 102. In embodiments, the first reflector 142 may be formed within the glass layer 110 by modifying the refractive index through a process such as laser writing.

In embodiments, an optical segment 120c is the light path formed within the glass layer 110 to transmit light from the first reflector 142 to a first end 132a of the first waveguide 132. In embodiments, the optical segment 120c may be formed by modifying the refractive index of the waveguide core region through a process such as laser writing.

Optical segment 120d may be a cavity formed within the glass layer 110 to transmit light from the second end 132b of the first waveguide 132, to a second reflector 144.

Optical segment 120e may be a cavity formed within the glass layer 110 to transmit light from the second reflector 144 to the first side 110a of the glass layer 110.

Optical segment 120f is a portion of the optical path between the top of the glass layer 110a and the PIC 107. Optical segment 120f may exist through the air between the second die 106 and the glass layer 110. In embodiments, a transparent underfill (not shown) below the second die 106 may be used as an optical transmission medium. It should be appreciated that characteristics of the optical segments such as first optical waveguide 132, as well as reflectors 142, 144, may be chosen based upon required refractive index contrasts to achieve a total internal reflection characteristic.

In embodiments, the second optical path 122 may have optical segments that are similar to those described above with respect to the first optical path 120, and include second optical waveguide 130.

Diagram 150 shows a top-down version of package 100, showing a first side 100a of the glass layer 110, to which the computing die 102, the first die 104, and the second die 106 are physically and optically coupled. Second optical waveguide 130 is shown within the glass layer 110 optically coupling with first die 104, and first optical waveguide 132 is shown within glass layer 110 optically coupling with the second die 106. Note that both optical waveguides are shown as curved in the x-y plane of the glass layer 110, and that the second optical waveguide 132 passes under the first die 104.

Other optical waveguides 134, 136 are shown optically coupled with computing die 102, and optically coupling other dies 115, 117. Note that the other optical waveguides 134, 136 are straight, with optical waveguide 136 at a deeper level within the glass layer 110 and passing underneath the die 115.

It should be noted that the z-depth of the x-y plane routing of the optical waveguides 130, 132, 134, 136 may be designed based upon high-speed I/O access between the computing die 102 and a tightly clustered set of dies 104, 106, 115, 117 that may not be adjacent to computing die 102, and may be positioned at a distance of 5 mm or more from the computing die 102 on the glass layer 110.

In embodiments, during package 100 design, attention should be paid so that both the electrical transceiver and the optical transceiver are optimized for short links, so that optical power consumption is within limits of a full power consumption target.

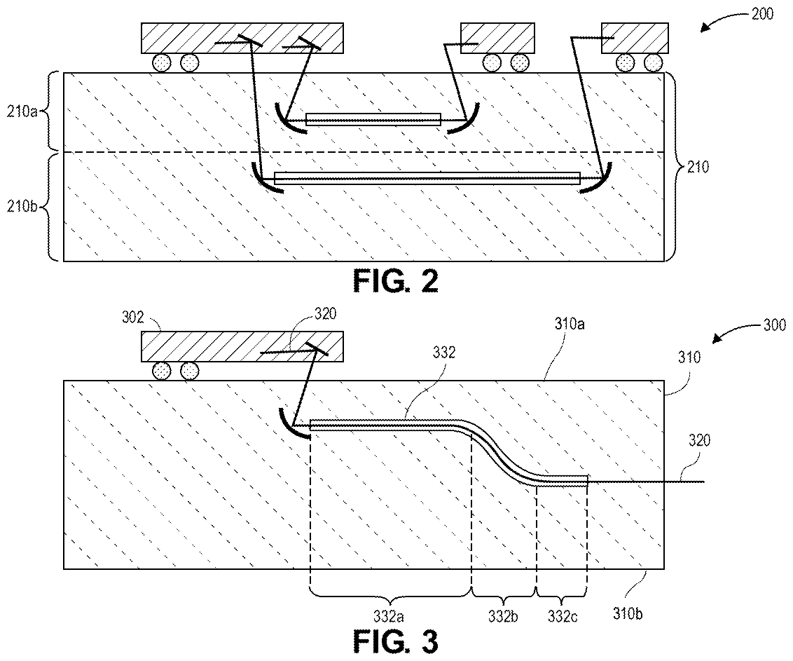

FIG. 2 illustrates a cross-section side view of a package that includes a computing die optically coupled with other dies using multiple waveguides within multiple glass layers, in accordance with various embodiments. Package 200, which may be similar to package 100 of FIG. 1, shows an embodiment where the glass layer 210, which may be similar to glass layer 110 of FIG. 1, is made up of multiple glass layers 210a, 210b that are coupled together. The technique shown with respect to package 200 may be used to create optical features as described with respect to package 100 in a simplified way, by creating a subset of those features onto individual glass layers 210a, 210b separately.

FIG. 3 illustrates a cross-section side view of a package that includes a computing die that is optically coupled with a waveguide in a glass layer that spans multiple depths within the glass layer, in accordance with various embodiments. Package 300, which may be similar to package 100 of FIG. 1 or package 200 of FIG. 2, includes a glass layer 310, which may be similar to glass layer 110 of FIG. 1. A computing die 302 and an optical path 320, which may be similar to computing die 102 and optical path 120 of FIG. 1, extends through the optical waveguide 332.

In embodiments, the optical waveguide 332 may be at different levels within the glass layer 310. A first section 332a may be at first depth of the glass layer that may be closer to the first side 310a. A third section 332c may be at a second depth of the glass layer that may be closer to the second side 310b. A transition section 332b may transition from the first section 332a to the third section 332c. In embodiments, the optical waveguide 332 may also vary within an x-y plane of the glass layer 310, as discussed in more detail with respect to diagram 150 of FIG. 1.

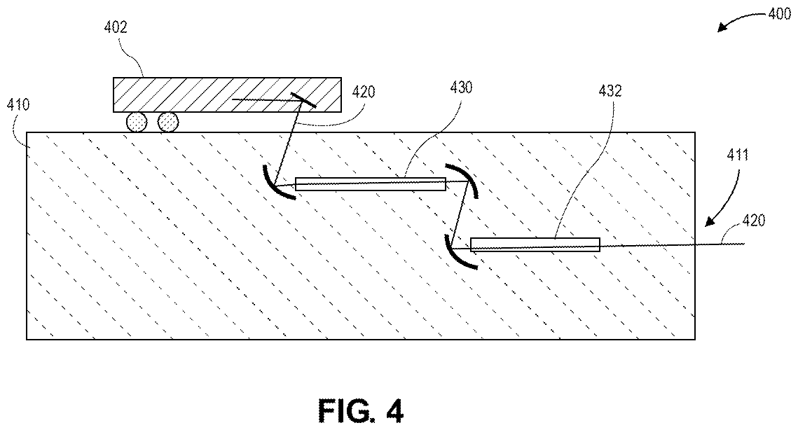

FIG. 4 illustrates a cross-section side view of a package that includes a computing die that is optically coupled in serial with multiple optical waveguides, in accordance with various embodiments. Package 400, which may be similar to package 300 of FIG. 3, shows an embodiment where an optical path 420, which may be similar to optical path 320 of FIG. 3, passes through a first optical waveguide 430 at a first depth within the glass layer 410, which may be similar to glass layer 110 of FIG. 1, and a second optical waveguide 432 at a second depth within the glass layer 410. The optical path 420 may have a first end at a PIC (not shown) within the computing die 402, which may be similar to PIC 103 within computing die 102 of FIG. 1. The optical path 420 may have a second end at an edge 411 of the glass layer 410.

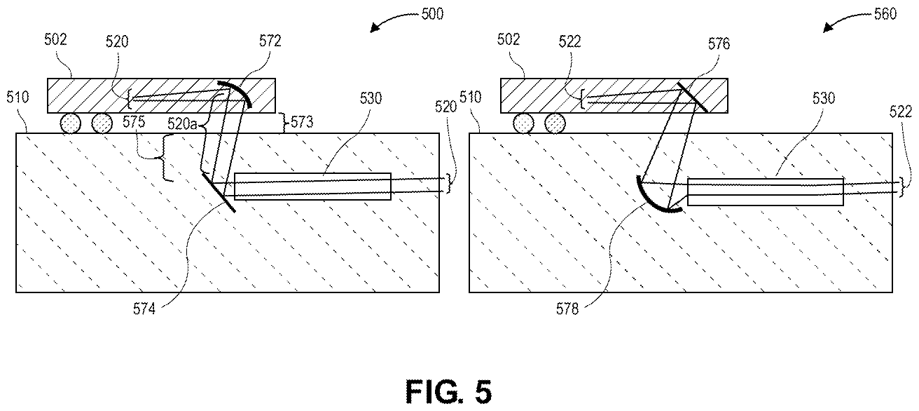

FIG. 5 illustrates cross-section side views of a package that includes a computing die that is optically coupled with a waveguide with different types of optical reflectors, in accordance with various embodiments. Package 500 and package 560 show two embodiments of a package that may be similar to package 100 of FIG. 1, with different types of reflectors that may control the diameter of a light beam as it passes through the glass layer 510. In this example embodiment, the optical waveguide 530 may be a single mode waveguide with an approximately 10 μm mode field diameter (MFD).

With respect to package 500, the first reflector 572 within a PIC of the computing die 502 may be a concave reflector, and used to generate a collimated beam of light around 10 μm MFD. The second reflector 574 is a planar reflector to directly couple light to the optical waveguide 530 with a matching MFD.

This approach has at least two advantages. First, a portion of a beam of light 520 may be converted by the concave reflector 572 into a collimated beam 520a with MFD at 10 μm that may have a reach of a few hundreds of micrometers. This reach may be sufficient to cover a distance that includes the computing die 502 bump 573 distance and interposer thickness 575 to the second reflector 574. As a result, in this embodiment, there is flexibility on propagation distance between the first reflector 572 and the second reflector 574 due to the collimated beam propagation. Second, the sizes of the first reflector 572 and the second reflector 574 can be relatively small, because the MFD of the light beam is about 10 μm.

With respect to package 560, the first reflector 576 within a PIC of the computing die 502 is a planar reflector, so that the beam 522 will expand before reaching the second reflector 578, which is a concave reflector, after which the beam re-converges before entering the optical waveguide 530. For example, the initial beam 522 width of 10 μm will expand to about 20-40 micrometers over this distance. Thus, the second reflector 578 is a converging reflector to cover the size of such bandwidth and provides radius of curvature that can convert the width of the beam 522 back to 10 μm for single mode optical waveguide compatibility. Based upon the glass layer 510 thickness and optical waveguide 530 depth, a larger size may be required for the second reflector 578.

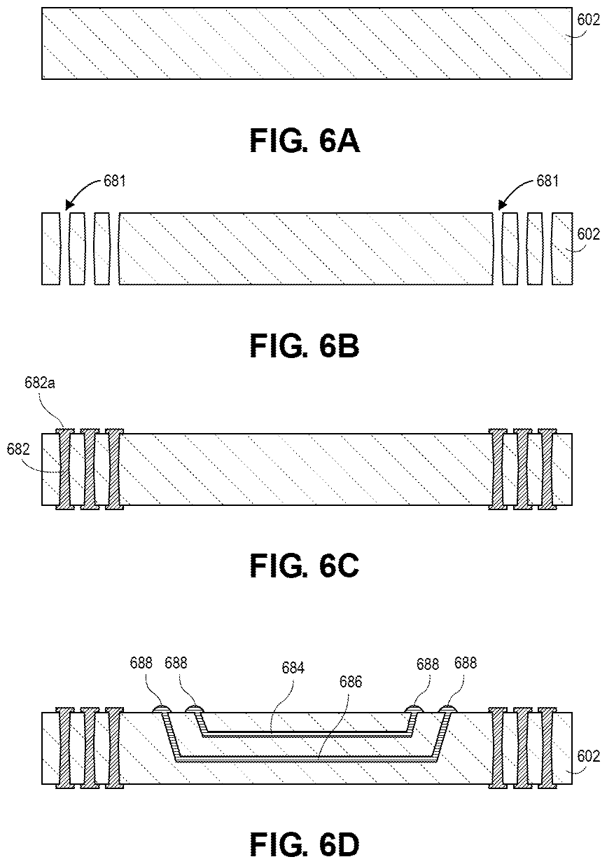

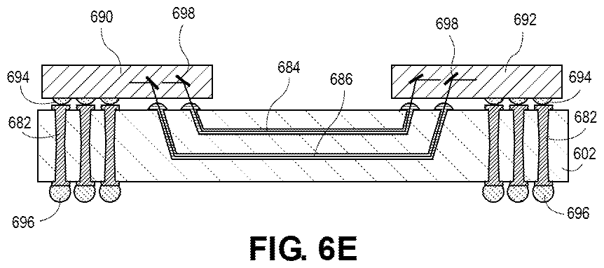

FIGS. 6A-6E illustrate stages in a manufacturing process for multiple waveguides in a glass layer, in accordance with various embodiments. FIG. 6A shows a stage in the manufacturing process where a glass layer 602 is identified. In embodiments, the glass layer 602 may be similar to glass layer 102 of FIG. 1.

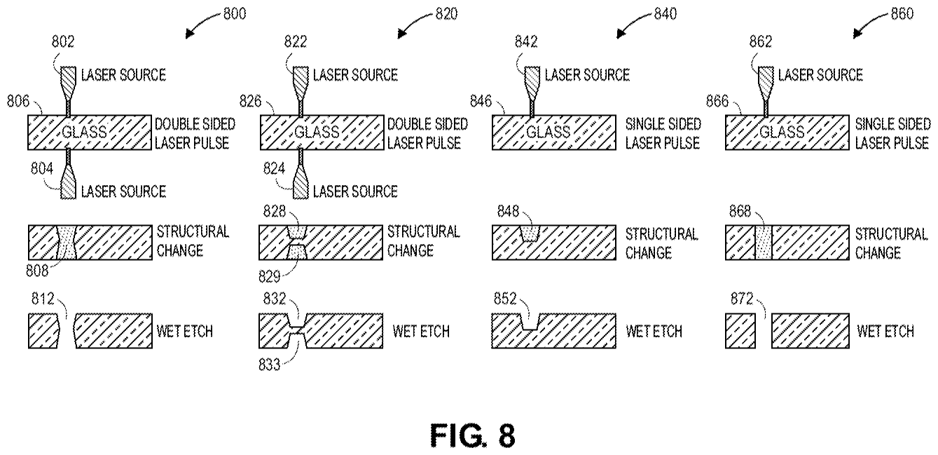

FIG. 6B shows a stage in the manufacturing process where TGVs 681 are formed in the glass layer 602. In embodiments, the TGVs 681 may be formed using techniques described below with respect to FIG. 8. Seed layers are then deposited on the surface and onto the sidewalls of the TGVs 681 for enabling subsequent electroplating. The seed layers can be deposited using an electro-less or sputter or atomic layer deposition (ALD) processes. The subsequent electroplating to fill the TGVs 681 is done using electrolytic plating. The extra copper that is plated on the glass surface may be polished or etched away to make the copper within the TGVs 681 flush with the glass layer 602 surface.

FIG. 6C shows a stage in the manufacturing process where TGVs 681 are filled with an electrically conductive material such as copper to form pillars 682. In embodiments, pads 682a made with the electrically conductive material may be physically coupled to either side of the pillars 682.

FIG. 6D shows a stage in the manufacturing process where optical waveguides 684, 686 are formed within the glass layer 602. In embodiments, these may be formed using techniques including laser direct writing. In embodiments, lenses 688 may be formed and optically coupled with the optical waveguides 684, 686 at a surface of the glass layer 602 to improve efficiency of light transmission through the optical waveguide 684, 686.

FIG. 6E shows a stage in the manufacturing process where PICs 690, 692 are electrically coupled with the pillars 682 using solder 694. Solder bumps 696 may be applied to the opposite side of the glass layer 602 in preparation for electrical coupling to a printed circuit board (PCB) (not shown). In embodiments, the PICs 690, 692 are optically coupled with the waveguides 684, 686, by using reflectors 698 within the PICs.

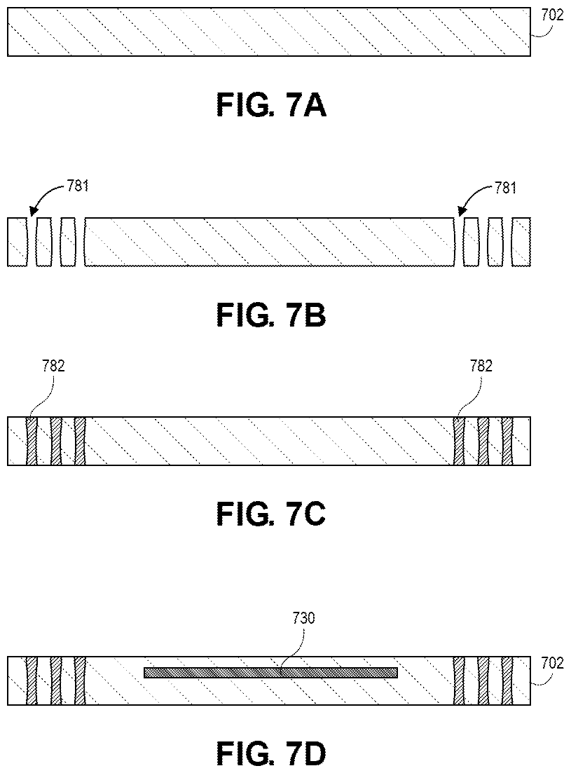

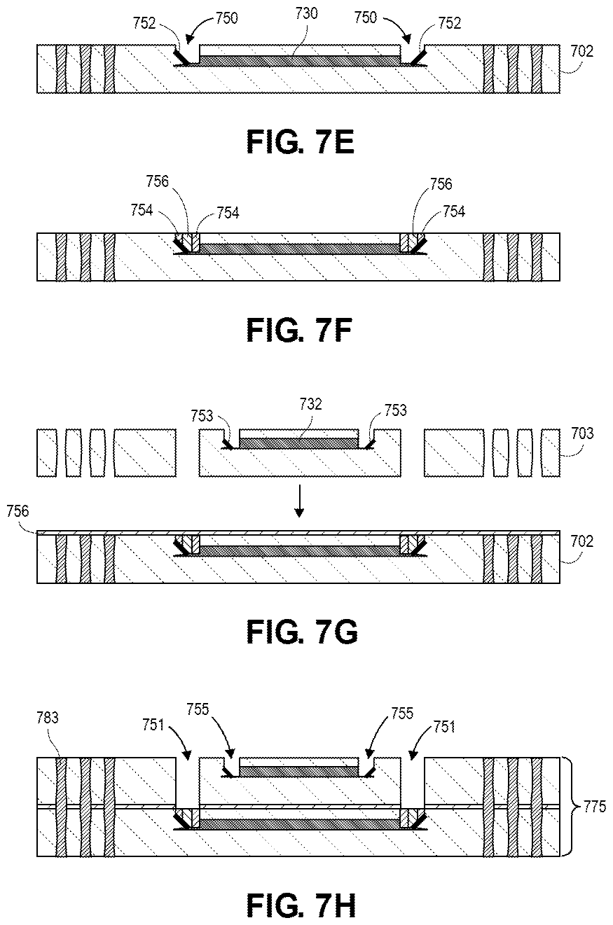

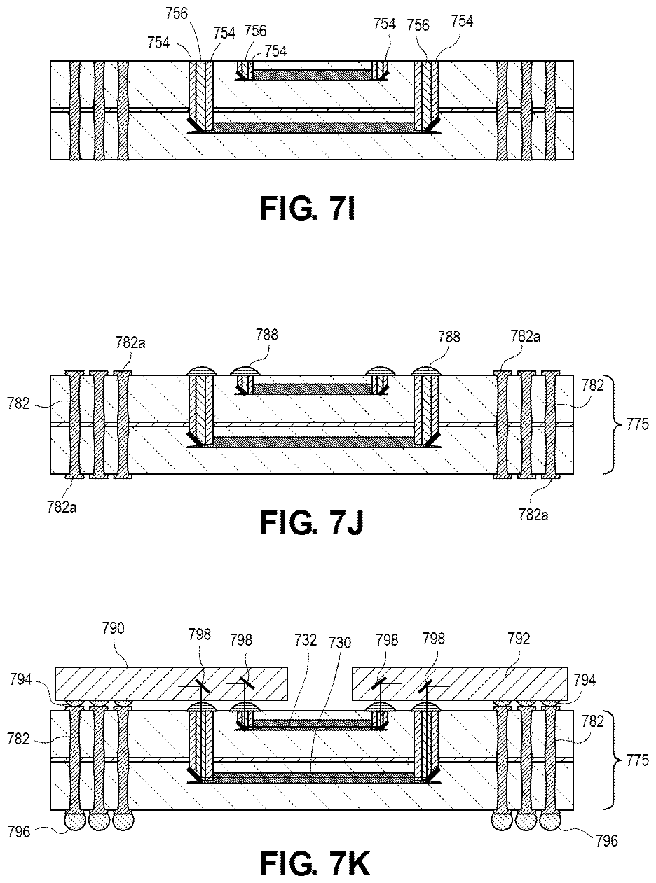

FIGS. 7A-7K illustrate stages in a manufacturing process for multiple waveguides using multiple glass layers, in accordance with various embodiments. FIG. 7A includes a stage in the manufacturing process where a first glass layer 702 is identified. In embodiments, the first glass layer 702 may be similar to glass layer 102 of FIG. 1.

FIG. 7B shows a stage in the manufacturing process where TGVs 781 are formed in the glass layer 702. In embodiments, the TGVs 781 may be formed using techniques described below with respect to FIG. 8 and as described with respect to FIG. 6B.

FIG. 7C shows a stage in the manufacturing process where TGVs 781 are filled with an electrically conductive material such as copper to form pillars 782.

FIG. 7D shows a stage in the manufacturing process where an embedded optical waveguide 730, which may be similar to optical waveguide 130 of FIG. 1, is formed at a depth within the glass layer 702. The embedded waveguides can be formed using approaches well known in the industry such as an ion-exchange process.

FIG. 7E shows a stage in the manufacturing process where cavities 750 are made in the top surface of the glass layer 702 and expose ends of the waveguide 730. Mirrors 752 are placed within the cavities 750. In embodiments the mirrors 752 may be placed at a 45° angle with respect to the waveguide 730.

FIG. 7F shows a stage in the manufacturing process where print clad material 754 and core material 756 are inserted in the cavities 750 to form optical transmission paths within the cavities 752. Standard cladding and core layers available in the industry can be used for making this path. This includes, but is not limited to, low-density versions of polyimides, polyalkanes, polycyanates, polyacrylates, polysiloxanes and thin metal layers such as copper, silver, gold, or aluminum. Additionally, any polyperflurocarbon (Teflon-like) polymer would work well as a cladding. The polymeric materials can be paste printed while the metal layers can be deposited using immersion processes for example.

FIG. 7G shows a stage in the manufacturing process where a second glass layer 703 which may be similar to glass layer 702, is created and patterned, and includes a second optical waveguide 732 with second mirrors 753 positioned at 45° angles on either ends of the second optical waveguide 732. An adhesive 756 may be coupled with a top of the first glass layer 702, and the glass layers 703, 702 are physically coupled.

FIG. 7H shows a stage in the manufacturing process where copper pillars 783 are formed within glass layer 775, which is a combination of glass layer 702 and glass layer 703 from FIG. 7G. The pillars or copper filled openings can be created using the process described in FIG. 6B above. The resulting glass layer 775 includes cavities 751 and 755. Cavities can be created by lasing followed by wet etch as described in FIG. 8 but not filled with copper.

FIG. 7I shows a stage in the manufacturing process where cavities 751, 755 are filled with print clad material 754 and core material 756 to form optical transmission paths. The print clad and core materials are made similar to that described in FIG. 7F above.

FIG. 7J shows a stage in the manufacturing process where lenses 788, which may be similar to lenses 688 of FIG. 6D, are placed on optical paths on a side of the glass layer 775. In addition, copper pads 782a may be formed on either side of the copper pillar 782.

FIG. 7K shows a stage in the manufacturing process where PICs 790, 792 are electrically coupled with the pillars 782 using solder 794. Solder bumps 796 may be applied to the opposite side of the glass layer 775 in preparation for electrical coupling to a printed circuit board (PCB) (not shown). In embodiments, the PICs 790, 792 are optically coupled with the waveguides 730, 732, by using reflectors 798 within the PICs.

FIG. 8 illustrates multiple examples of laser-assisted etching of glass interconnects processes (which may be referred to as “LEGIT” herein), in accordance with embodiments. One use of the LEGIT technique is to provide an alternative substrate core material to the legacy copper clad laminate (CCL) core used in semiconductor packages used to implement products such as servers, graphics, clients, 5G, and the like. By using laser-assisted etching, crack free, high density via drills, hollow shapes may be formed into a glass substrate. In embodiments, different process parameters may be adjusted to achieve drills of various shapes and depths, thus opening the door for innovative devices, architectures, processes, and designs in glass. Embodiments, such as the bridge discussed herein, may also take advantage of these techniques.

Diagram 800 shows a high level process flow for a through via and blind via (or trench) in a microelectronic package substrate (e.g. glass) using LEGIT to create a through via or a blind via. A resulting volume/shape of glass with laser-induced morphology change that can then be selectively etched to create a trench, a through hole or a void that can be filled with conductive material. A through via 812 is created by laser pulses from two laser sources 802, 804 on opposite sides of a glass wafer 806. As used herein, a through drill and a through via refers to when the drill or the via starts on one side of the glass/substrate and ends on the other side. A blind drill and a blind via refers to when the drill or the via starts on the surface of the substrate and stops half way inside the substrate. In embodiments, the laser pulses from the two laser sources 802, 804 are applied perpendicularly to the glass wafer 806 to induce a morphological change 808, which may also be referred to as a structural change, in the glass that encounters the laser pulses. This morphological change 808 includes changes in the molecular structure of the glass to make it easier to etch out (remove a portion of the glass). In embodiments, a wet etch process may be used.

Diagram 820 shows a high level process flow for a double blind shape. A double blind shape 832, 833 may be created by laser pulses from two laser sources 822, 824, which may be similar to laser sources 802, 804, that are on opposite sides of the glass wafer 826, which may be similar to glass wafer 806. In this example, adjustments may be made in the laser pulse energy and/or the laser pulse exposure time from the two laser sources 822, 824. As a result, morphological changes 828, 829 in the glass 826 may result, with these changes making it easier to etch out portions of the glass. In embodiments, a wet etch process may be used.

Diagram 840 shows a high level process flow for a single-blind shape, which may also be referred to as a trench. In this example, a single laser source 842 delivers a laser pulse to the glass wafer 846 to create a morphological change 848 in the glass 846. As described above, these morphological changes make it easier to etch out a portion of the glass 852. In embodiments, a wet etch process may be used.

Diagram 860 shows a high level process flow for a through via shape. In this example, a single laser source 862 applies a laser pulse to the glass 866 to create a morphological change 868 in the glass 866, with the change making it easier to etch out a portion of the glass 872. As shown here, the laser pulse energy and/or laser pulse exposure time from the laser source 862 has been adjusted to create an etched out portion 872 that extends entirely through the glass 866.

With respect to FIG. 8, although embodiments show laser sources 802, 804, 822, 824, 842, 862 as perpendicular to a surface of the glass 806, 826, 846, 866, in embodiments, the laser sources may be positioned at an angle to the surface of the glass, with pulse energy and/or pulse exposure time variations in order to cause a diagonal via or a trench, or to shape the via, such as 812, 872, for example to make it cylindrical, tapered, or include some other feature. In addition, varying the glass type may also cause different features within a via or a trench as the etching of glass is strongly dependent on the chemical composition of the glass.

In embodiments using the process described with respect to FIG. 8, through hole vias 812, 872 may be created that are less than 10 μm in diameter, and may have an aspect ratio of 40:1 to 50:1. As a result, a far higher density of vias may be placed within the glass and be placed closer to each other at a fine pitch. In embodiments, this pitch may be 50 μm or less. After creating the vias or trenches, a metallization process may be applied in order to create a conductive pathway through the vias or trenches, for example a plated through hole (PTH). Using these techniques, finer pitch vias may result in better signaling, allowing more I/O signals to be routed through the glass wafer and to other coupled components such as a substrate.

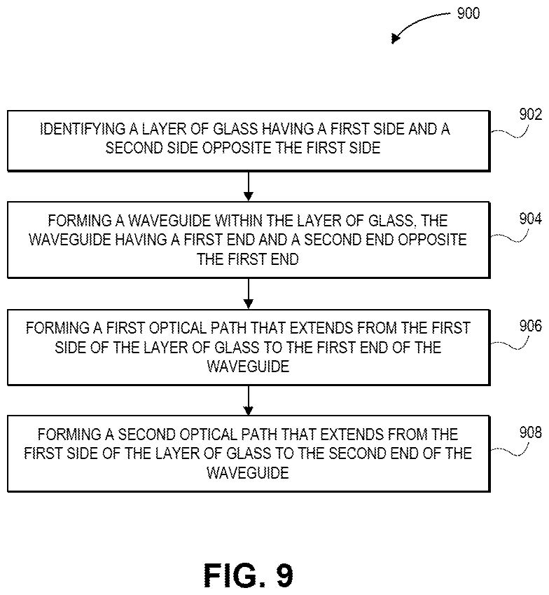

FIG. 9 illustrates an example of a process for coupling an open cavity PIC with a thermal/power die, in accordance with various embodiments. Process 900 may be performed using the techniques, methods, systems, and/or apparatus as described with respect to FIGS. 1-8.

At block 902, the process may include identifying a layer of glass having a first side and a second side opposite the first side.

At block 904, the process may further include forming a waveguide within the layer of glass, the waveguide having a first end and a second end opposite the first end.

At block 906, the process may further include forming a first optical path that extends from the first side of the layer of glass to the first end of the waveguide.

At block 908, the process may further include forming a second optical path that extends from the first side of the layer of glass to the second end of the waveguide.

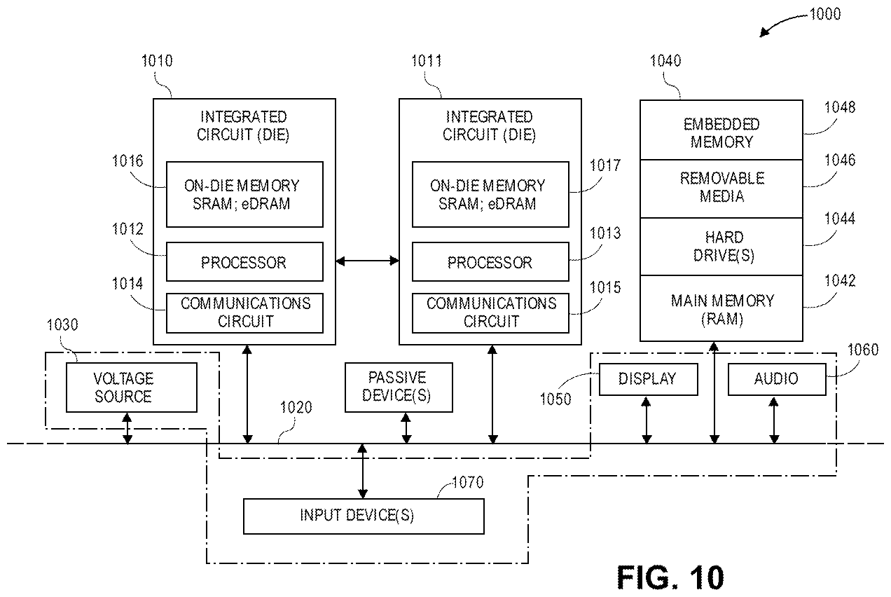

FIG. 10 is a schematic of a computer system 1000, in accordance with an embodiment of the present invention. The computer system 1000 (also referred to as the electronic system 1000) as depicted can embody optical waveguides within a glass substrate to optically coupled dies attached to the glass substrate, according to any of the several disclosed embodiments and their equivalents as set forth in this disclosure. The computer system 1000 may be a mobile device such as a netbook computer. The computer system 1000 may be a mobile device such as a wireless smart phone. The computer system 1000 may be a desktop computer. The computer system 1000 may be a hand-held reader. The computer system 1000 may be a server system. The computer system 1000 may be a supercomputer or high-performance computing system.

In an embodiment, the electronic system 1000 is a computer system that includes a system bus 1020 to electrically couple the various components of the electronic system 1000. The system bus 1020 is a single bus or any combination of busses according to various embodiments. The electronic system 1000 includes a voltage source 1030 that provides power to the integrated circuit 1010. In some embodiments, the voltage source 1030 supplies current to the integrated circuit 1010 through the system bus 1020.

The integrated circuit 1010 is electrically coupled to the system bus 1020 and includes any circuit, or combination of circuits according to an embodiment. In an embodiment, the integrated circuit 1010 includes a processor 1012 that can be of any type. As used herein, the processor 1012 may mean any type of circuit such as, but not limited to, a microprocessor, a microcontroller, a graphics processor, a digital signal processor, or another processor. In an embodiment, the processor 1012 includes, or is coupled with, optical waveguides within a glass substrate to optically coupled dies attached to the glass substrate, as disclosed herein. In an embodiment, SRAM embodiments are found in memory caches of the processor. Other types of circuits that can be included in the integrated circuit 1010 are a custom circuit or an application-specific integrated circuit (ASIC), such as a communications circuit 1014 for use in wireless devices such as cellular telephones, smart phones, pagers, portable computers, two-way radios, and similar electronic systems, or a communications circuit for servers. In an embodiment, the integrated circuit 1010 includes on-die memory 1016 such as static random-access memory (SRAM). In an embodiment, the integrated circuit 1010 includes embedded on-die memory 1016 such as embedded dynamic random-access memory (eDRAM).

In an embodiment, the integrated circuit 1010 is complemented with a subsequent integrated circuit 1011. Useful embodiments include a dual processor 1013 and a dual communications circuit 1015 and dual on-die memory 1017 such as SRAM. In an embodiment, the dual integrated circuit 1010 includes embedded on-die memory 1017 such as eDRAM.

In an embodiment, the electronic system 1000 also includes an external memory 1040 that in turn may include one or more memory elements suitable to the particular application, such as a main memory 1042 in the form of RAM, one or more hard drives 1044, and/or one or more drives that handle removable media 1046, such as diskettes, compact disks (CDs), digital variable disks (DVDs), flash memory drives, and other removable media known in the art. The external memory 1040 may also be embedded memory 1048 such as the first die in a die stack, according to an embodiment.

In an embodiment, the electronic system 1000 also includes a display device 1050, an audio output 1060. In an embodiment, the electronic system 1000 includes an input device such as a controller 1070 that may be a keyboard, mouse, trackball, game controller, microphone, voice-recognition device, or any other input device that inputs information into the electronic system 1000. In an embodiment, an input device 1070 is a camera. In an embodiment, an input device 1070 is a digital sound recorder. In an embodiment, an input device 1070 is a camera and a digital sound recorder.

As shown herein, the integrated circuit 1010 can be implemented in a number of different embodiments, including a package substrate having optical waveguides within a glass substrate to optically coupled dies attached to the glass substrate, according to any of the several disclosed embodiments and their equivalents, an electronic system, a computer system, one or more methods of fabricating an integrated circuit, and one or more methods of fabricating an electronic assembly that includes a package substrate having optical waveguides within a glass substrate to optically coupled dies attached to the glass substrate, according to any of the several disclosed embodiments as set forth herein in the various embodiments and their art-recognized equivalents. The elements, materials, geometries, dimensions, and sequence of operations can all be varied to suit particular I/O coupling requirements including array contact count, array contact configuration for a microelectronic die embedded in a processor mounting substrate according to any of the several disclosed package substrates having optical waveguides within a glass substrate to optically coupled dies attached to the glass substrate embodiments and their equivalents. A foundation substrate may be included, as represented by the dashed line of FIG. 10. Passive devices may also be included, as is also depicted in FIG. 10.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated embodiments, including what is described in the Abstract, is not intended to be exhaustive or to limit embodiments to the precise forms disclosed. While specific embodiments are described herein for illustrative purposes, various equivalent modifications are possible within the scope of the embodiments, as those skilled in the relevant art will recognize.

These modifications may be made to the embodiments in light of the above detailed description. The terms used in the following claims should not be construed to limit the embodiments to the specific implementations disclosed in the specification and the claims. Rather, the scope of the invention is to be determined entirely by the following claims, which are to be construed in accordance with established doctrines of claim interpretation.

The following paragraphs describe examples of various embodiments.

### Examples

Example 1 is an apparatus, comprising: a glass substrate with a first side and a second side opposite the first side; a first optical path that extends from the first side of the glass substrate toward the second side of the glass substrate; and an optical waveguide within the glass substrate, the optical waveguide with a first end that is optically coupled with the first optical path and with a second end opposite the first end that is coupled with a second optical path.

Example 2 includes the apparatus of example 1, further comprising a reflector within the glass substrate, a portion of the reflector intersecting the first optical path and aligned with the first end of the optical waveguide.

Example 3 includes the apparatus of example 2, wherein the reflector is a selected one of: a flat reflector or a curved reflector.

Example 4 includes the apparatus of example 2, further comprising a third optical path that extends from the portion of the reflector to the first end of the optical waveguide.

Example 5 includes the apparatus of example 2, wherein the second optical path extends to an optical coupler at an edge of the glass substrate.

Example 6 includes the apparatus of example 2, wherein the reflector is a first reflector; and further comprising a second reflector within the glass substrate, a portion of the second reflector intersecting the second optical path and aligned with the second end of the optical waveguide.

Example 7 includes the apparatus of example 6, wherein the second reflector is a selected one of: a flat reflector or a curved reflector.

Example 8 includes the apparatus of example 6, further comprising a fourth optical path that extends from the portion of the second reflector to the second end of the optical waveguide.

Example 9 includes the apparatus of example 8, wherein the second optical path extends to a selected one of: the first side of the glass substrate or the second side of the glass substrate.

Example 10 includes the apparatus of example 6, wherein the optical waveguide is a first optical waveguide; and further comprising: a second optical waveguide within the glass layer, the second optical waveguide with a first end and a second end opposite the first end, the first end of the second optical waveguide optically coupled with the second optical path.

Example 11 includes the apparatus of example 10, further comprising: a third reflector within the glass substrate, a portion of the third reflector intersecting the second optical path and aligned with the first end of the second optical waveguide; and a fifth optical path that extends from the second end of the optical waveguide.

Example 12 includes the apparatus of example 10, wherein the first optical waveguide and the second optical waveguide are at different distances from the first side of the glass layer.

Example 13 includes the apparatus of example 1, wherein the first optical path and the second optical path include air.

Example 14 includes the apparatus of example 1, wherein the optical waveguide is parallel to the first side of the glass substrate.

Example 15 includes the apparatus of example 1, wherein the optical waveguide has a first portion that is parallel to the first side of the glass layer and a second portion that is parallel to the first side of the glass layer, and wherein the first portion of the optical waveguide is at a first distance from the first side of the glass layer, and the second portion of the optical waveguide is at a second distance from the first side of the glass layer.

Example 16 includes the apparatus of example 1, wherein the first optical path or the second optical path is an optical waveguide.

Example 17 includes the apparatus of any one of examples 1-16, wherein the first optical path or the second optical path include an optical lens.

Example 18 is a method comprising: identifying a layer of glass having a first side and a second side opposite the first side; forming a waveguide within the layer of glass, the waveguide having a first end and a second end opposite the first end; forming a first optical path that extends from the first side of the layer of glass to the first end of the waveguide; and forming a second optical path that extends from the first side of the layer of glass to the second end of the waveguide.

Example 19 includes the method of example 18, wherein the first optical path or the second optical path are air.

Example 20 includes the method of example 18, wherein forming the first optical path further includes forming a reflector in the first optical path, a portion of the reflector intersects the second optical path and aligns with the first end of the optical waveguide.

Example 21 includes the method of example 18, wherein forming the waveguide within the layer of glass further includes forming the waveguide along a plane that is substantially parallel to a plane of the first side of the layer of glass.

Example 22 includes the method of any one of examples 18-21, wherein forming the waveguide further includes forming the waveguide using a selected one of: a laser writing process, ion-exchange, a hermetic bonding process, or a eutetic bonding process.

Example 23 is a package comprising: a first die coupled with a side of a glass layer; a second die physically and optically coupled with the side of the glass layer; and the glass layer comprising: an optical waveguide within the glass layer, the optical waveguide with a first end that is optically coupled with the first optical path and with a second end opposite the first end that is coupled with a second optical path; a first optical path optically coupled with the first end of the optical waveguide and the side of the glass layer; a second optical path optically coupled with the second end of the optical waveguide and the side of the glass layer; and wherein the first optical path is optically coupled with the first die, and wherein the second optical path is optically coupled with the second die.

Example 24 includes the package of example 23, wherein the optical waveguide is a multi-layer optical waveguide.

Example 25 includes the package of any one of examples 23-24, wherein an optical coupling of the first die and an optical coupling of the second die are at a distance of greater than 5 mm along the side of the glass layer.

What is claimed is:

1. An apparatus, comprising:
a glass substrate with a first side and a second side opposite the first side;
a first optical path that extends from the first side of the glass substrate toward the second side of the glass substrate; and
an optical waveguide within the glass substrate, the optical waveguide with a first end that is optically coupled with the first optical path and with a second end opposite the first end that is coupled with a second optical path.

2. The apparatus of claim 1, further comprising a reflector within the glass substrate, a portion of the reflector intersecting the first optical path and aligned with the first end of the optical waveguide.

3. The apparatus of claim 2, wherein the reflector is a selected one of: a flat reflector or a curved reflector.

4. The apparatus of claim 2, further comprising a third optical path that extends from the portion of the reflector to the first end of the optical waveguide.

5. The apparatus of claim 2, wherein the second optical path extends to an optical coupler at an edge of the glass substrate.

6. The apparatus of claim 2, wherein the reflector is a first reflector; and further comprising a second reflector within the glass substrate, a portion of the second reflector intersecting the second optical path and aligned with the second end of the optical waveguide.

7. The apparatus of claim 6, wherein the second reflector is a selected one of: a flat reflector or a curved reflector.

8. The apparatus of claim 6, further comprising a fourth optical path that extends from the portion of the second reflector to the second end of the optical waveguide.

9. The apparatus of claim 8, wherein the second optical path extends to a selected one of: the first side of the glass substrate or the second side of the glass substrate.

10. The apparatus of claim 6, wherein the optical waveguide is a first optical waveguide; and further comprising:
a second optical waveguide within the glass layer, the second optical waveguide with a first end and a second end opposite the first end, the first end of the second optical waveguide optically coupled with the second optical path.

11. The apparatus of claim 10, further comprising:
a third reflector within the glass substrate, a portion of the third reflector intersecting the second optical path and aligned with the first end of the second optical waveguide; and
a fifth optical path that extends from the second end of the optical waveguide.

12. The apparatus of claim 10, wherein the first optical waveguide and the second optical waveguide are at different distances from the first side of the glass layer.

13. The apparatus of claim 1, wherein the first optical path and the second optical path include air.

14. The apparatus of claim 1, wherein the optical waveguide is parallel to the first side of the glass substrate.

15. The apparatus of claim 1, wherein the optical waveguide has a first portion that is parallel to the first side of the glass layer and a second portion that is parallel to the first side of the glass layer, and wherein the first portion of the optical waveguide is at a first distance from the first side of the glass layer, and the second portion of the optical waveguide is at a second distance from the first side of the glass layer.

16. The apparatus of claim 1, wherein the first optical path or the second optical path is an optical waveguide.

17. The apparatus of claim 1, wherein the first optical path or the second optical path include an optical lens.

18. A method comprising:
identifying a layer of glass having a first side and a second side opposite the first side;
forming a waveguide within the layer of glass, the waveguide having a first end and a second end opposite the first end;
forming a first optical path that extends from the first side of the layer of glass to the first end of the waveguide; and
forming a second optical path that extends from the first side of the layer of glass to the second end of the waveguide.

19. The method of claim 18, wherein the first optical path or the second optical path are air.

20. The method of claim 18, wherein forming the first optical path further includes forming a reflector in the first optical path, a portion of the reflector intersects the second optical path and aligns with the first end of the optical waveguide.

21. The method of claim 18, wherein forming the waveguide within the layer of glass further includes forming the waveguide along a plane that is substantially parallel to a plane of the first side of the layer of glass.

22. The method of claim 18, wherein forming the waveguide further includes forming the waveguide using a selected one of: a laser writing process, ion-exchange, a hermetic bonding process, or a eutetic bonding process.

23. A package comprising:
a first die coupled with a side of a glass layer;
a second die physically and optically coupled with the side of the glass layer; and
the glass layer comprising:
an optical waveguide within the glass layer, the optical waveguide with a first end that is optically coupled with the first optical path and with a second end opposite the first end that is coupled with a second optical path;
a first optical path optically coupled with the first end of the optical waveguide and the side of the glass layer;
a second optical path optically coupled with the second end of the optical waveguide and the side of the glass layer; and
wherein the first optical path is optically coupled with the first die, and wherein the second optical path is optically coupled with the second die.

24. The package of claim 23, wherein the optical waveguide is a multi-layer optical waveguide.

25. The package of claim 23, wherein an optical coupling of the first die and an optical coupling of the second die are at a distance of greater than 5 mm along the side of the glass layer.
